(19) United States
(12) Patent Application Publication
(10) Pub. No.: US 2009/0096749 A1
(43) Pub. Date: Apr. 16, 2009

(54) PORTABLE DEVICE INPUT TECHNIQUE

(75) Inventors: Hideya Kawahara, Mountain View, CA (US); Akihiko Kusanagi, Tokyo (JP)

Correspondence Address: PVF -- SUN MICROSYSTEMS INC.;C/O PARK, VAUGHAN & FLEMING LLP, 2820 FIFTH STREET, DAVIS, CA, 95618-7759, US

(73) Assignee: SUN MICROSYSTEMS, INC., Santa Clara, CA (US)

(21) Appl. No.: 11/869,985

(22) Filed: Oct. 10, 2007

(51) Int. Cl. G06F 3/033; G06F 3/041

(52) U.S. Cl. 345/162; 345/173

(57) ABSTRACT

Some embodiments of the present invention provide a portable device that receives user input. The portable device includes a touchpad and a display screen on opposite sides of the portable device. During operation, the portable device obtains a position on the touchpad provided by a user, obtains a screen position from the position by transposing a coordinate of the position, and updates the display screen using the screen position.

### BACKGROUND

1. Field

The present invention relates to techniques for receiving user input in a portable device. More specifically, the present invention relates to a method and apparatus for receiving user input from a touchpad located on one side of the portable device and updating a display screen on an opposite side of the portable device with the user input.

2. Related Art

Portable devices, such as mobile phones, personal digital assistants (PDAs), portable computers, and portable media players, have become increasingly versatile over the years. A single portable device may function as a mobile phone, web browser, portable media player, email client, document editor, and global positioning system (GPS) receiver. Similarly, portable computers such as tablet personal computers (PCs) may incorporate the functionalities of full operating systems and application suites into pocket-sized gadgets. Portable devices may also provide one or more user-input mechanisms, such as touch screens, touchpads, pointing sticks, trackballs, automated speech recognition systems, and/or buttons, to interact with the user.

A typical portable device may include a graphical user interface (GUI) with multiple menus and sub-menus, icons, virtual buttons, and/or windows. To accommodate the added functionalities of modern portable devices, more GUI elements may be included in the portable device's display screen. Consequently, the GUI elements may be smaller in size and/or placed closer together, creating potential usability problems with current input methods. For example, pointing sticks, trackballs, and/or directional buttons may be slow, unwieldy, and/or unintuitive to use in a display screen with many GUI elements. Similarly, touch screens may be obscured by fingers, styluses, and/or other pointing implements, and may also accumulate fingerprints and/or scratches from continual use. As a result, user interactivity with current portable devices may be limited by lack of ergonomic, intuitive, and/or efficient user input mechanisms.

### SUMMARY

Some embodiments of the present invention provide a portable device that receives user input. The portable device includes a touchpad and a display screen on opposite sides of the portable device. During operation, the portable device obtains a position on the touchpad provided by a user and then generates a screen position from the position by transposing a coordinate of the position. Finally, the portable device updates the display screen using the screen position.

In some embodiments, the portable device also includes a sub-screen that is updated using the non-transposed position when the portable device is in a closed configuration.

In some embodiments, the touchpad is overlaid on the sub-screen.

In some embodiments, the system also obtains a selection of the screen position from the user and updates the display screen using the selection and the screen position.

In some embodiments, the selection is provided using at least one of increased pressure on the touchpad, a tap on the touchpad, and a press of a button on the portable device.

In some embodiments, the system also:
(1) obtains a movement across the touchpad by the user,
(2) determines a direction of the movement,
(3) obtains a screen movement from the movement by transposing a component of the direction, and
(4) updates the display screen using the screen movement.

In some embodiments, the movement corresponds to at least one of relative motion and absolute motion on the display screen.

In some embodiments, the portable device is at least one of a personal digital assistant (PDA), a mobile phone, a portable media player, a global positioning system (GPS) receiver, and a portable computer.

In some embodiments, the screen position is further obtained by scaling one or more coordinates of the position.

In some embodiments, the display screen is updated using at least one of a cursor, a highlight, an icon selection, a menu item selection, a virtual button press, and an area selection.

### BRIEF DESCRIPTION OF THE FIGURES

FIG. 1 shows a schematic diagram of a portable device in accordance with an embodiment of the present invention.

FIGS. 2A-2E show exemplary portable devices in accordance with an embodiment of the present invention.

FIG. 3 shows a flow chart of processing user input in a portable device in accordance with an embodiment of the present invention.

### DETAILED DESCRIPTION

The following description is presented to enable any person skilled in the art to make and use the disclosed embodiments, and is provided in the context of a particular application and its requirements. Various modifications to the disclosed embodiments will be readily apparent to those skilled in the art, and the general principles defined herein may be applied to other embodiments and applications without departing from the spirit and scope of the present description. Thus, the present description is not intended to be limited to the embodiments shown, but is to be accorded the widest scope consistent with the principles and features disclosed herein.

The data structures and code described in this detailed description are typically stored on a computer-readable storage medium, which may be any device or medium that can store code and/or data for use by a computer system. This includes, but is not limited to, volatile memory, non-volatile memory, magnetic and optical storage devices such as disk drives, magnetic tape, CDs (compact discs), DVDs (digital versatile discs or digital video discs), or other media capable of storing computer-readable media now known or later developed.

Embodiments of the invention provide a method and apparatus to receive user input in a portable device. Portable devices may include mobile phones, personal digital assistants (PDAs), global positioning system (GPS) receivers, portable media players, and/or portable (e.g., laptop, tablet, etc.) computers.

Specifically, embodiments of the invention provide a method and apparatus to allow users to point to and select GUI elements on a display screen of a portable device. The portable device may include a touchpad located on an opposite side of the portable device from the display screen. The user may point to and/or select one or more areas of the display screen by contacting the touchpad using a fingertip and/or stylus. Positions on the touchpad may be mapped to positions on the display screen by transposing a touchpad coordinate and/or scaling one or more touchpad coordinates. The display screen may then be updated using the screen position.

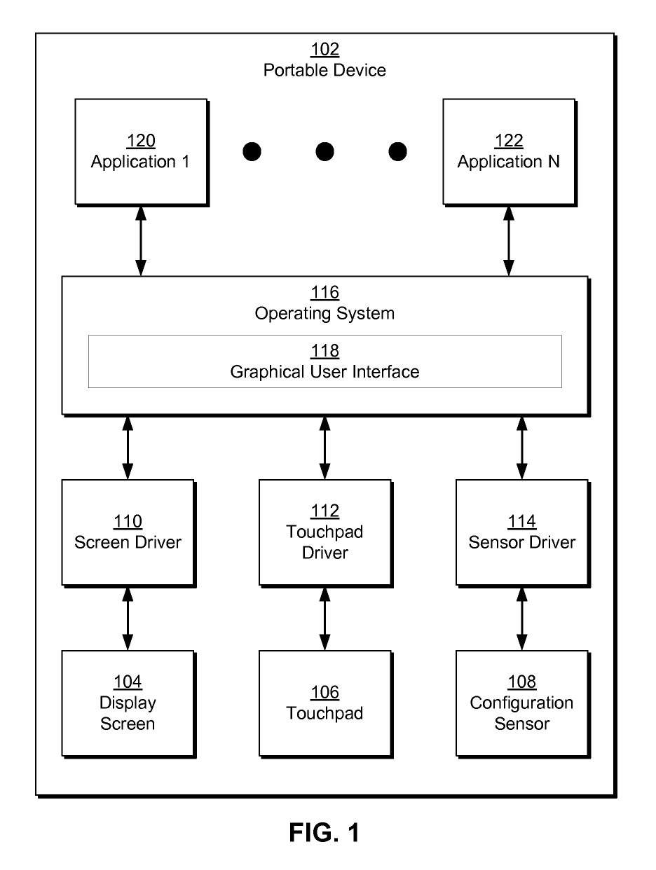

FIG. 1 shows a schematic diagram of a portable device in accordance with an embodiment of the present invention. As shown in FIG. 1, portable device 102 includes a display screen 104, a touchpad 106, a configuration sensor 108, a screen driver 110, a touchpad driver 112, a sensor driver 114, an operating system 116, and multiple applications (e.g., application 1 120, application n 122). Each of these components is described in further detail below.

Portable device 102 may correspond to a portable electronic device that provides one or more services or functions to a user. For example, portable device 102 may operate as a mobile phone, portable computer, global positioning system (GPS) receiver, portable media player, and/or graphing calculator. In addition, portable device 102 may include an operating system 116 that coordinates the use of hardware and software resources on portable device 102, as well as one or more applications (e.g., application 1 120, application n 122) that perform specialized tasks for the user. For example, portable device 102 may include applications (e.g., application 1 120, application n 122) such as an email client, an address book, a document editor, and/or a media player. To perform tasks for the user, applications (e.g., application 1 120, application n 122) may obtain the use of hardware resources (e.g., processor, memory, I/O components, wireless transmitter, etc.) on portable device 102 from operating system 116, as well as interact with the user through a hardware and/or software framework provided by operating system 116, as described below.

To enable interaction with the user, portable device 102 may include one or more hardware input/output (I/O) components, such as display screen 104, touchpad 106, and configuration sensor 108. Each hardware I/O component may additionally be associated with a software driver (e.g., screen driver 110, touchpad driver 112, sensor driver 114) that allows operating system 116 and/or applications (e.g., application 1 120, application n 122) on portable device 102 to access and use the hardware I/O components.

Display screen 104 may be used to display images and/or text to one or more users of portable device 102. In one or more embodiments of the invention, display screen 104 serves as the primary hardware output component for portable device 102. For example, display screen 104 may allow the user(s) to view menus, icons, windows, emails, websites, videos, pictures, maps, documents, and/or other components of a graphical user interface (GUI) 118 provided by operating system 116. Those skilled in the art will appreciate that display screen 104 may incorporate various types of display technology to render and display images. For example, display screen 104 may be a liquid crystal display (LCD), an organic light-emitting diode (OLED) display, a surface-conducting electron-emitter display (SED), and/or other type of electronic display.

Touchpad 106 may function as the primary hardware input component of portable device 102. Specifically, touchpad 106 may allow the user to point to and/or select one or more areas of display screen 104 using a cursor, for example. Input provided by the user using touchpad 106 may be processed by touchpad driver 112 and sent to operating system 116 and/or one or more applications (e.g., application 1 120, application n 122). Touchpad 106 may receive user input using various types of technology, including resistive, capacitive, surface acoustic wave (SAW), infrared, and/or optical imaging. In addition, touchpad 106 may correspond to a multi-point touchpad, allowing the user to specify multiple positions simultaneously on touchpad 106 and/or perform actions such as zooming and/or selecting multiple areas simultaneously on display screen 104. On the other hand, touchpad 106 may simply include a grid of buttons that map to areas of display screen 104. Operating system 116 and/or the application(s) (e.g., application 1 120, application n 122) may then use the input to perform one or more tasks, as well as update GUI 118 in response. Images corresponding to GUI 118 may be sent by operating system 116 to screen driver 110, which may display the images on display screen 104 as a series of pixels. As a result, the user may interact with portable device 102 by providing input to operating system 116 and/or applications (e.g., application 1 120, application n 122) using touchpad 106 and receiving output from operating system 116 and/or applications (e.g., application 1 120, application n 122) using display screen 104.

In one or more embodiments of the invention, touchpad 106 may be positioned on an opposite side of portable device 102 from display screen 104. In other words, portable device 102 may be used by positioning display screen 104 to face towards the user, thus allowing the user to view display screen 104, and consequently positioning touchpad 106 to face away from the user. The user may point, select, scroll, drag, zoom, and/or perform other actions on display screen 104 by using a fingertip, stylus, and/or other pointing implement on touchpad 106. In addition, due to the positioning of touchpad 106 and display screen 104 on portable device 102, the user may have an unobstructed view of display screen 104 while providing input to portable device 102 using touchpad 106.

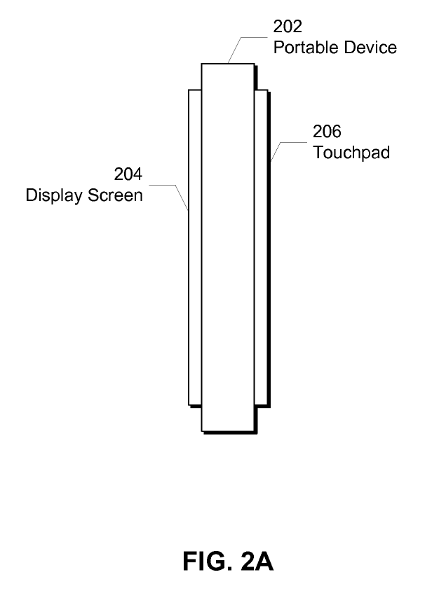

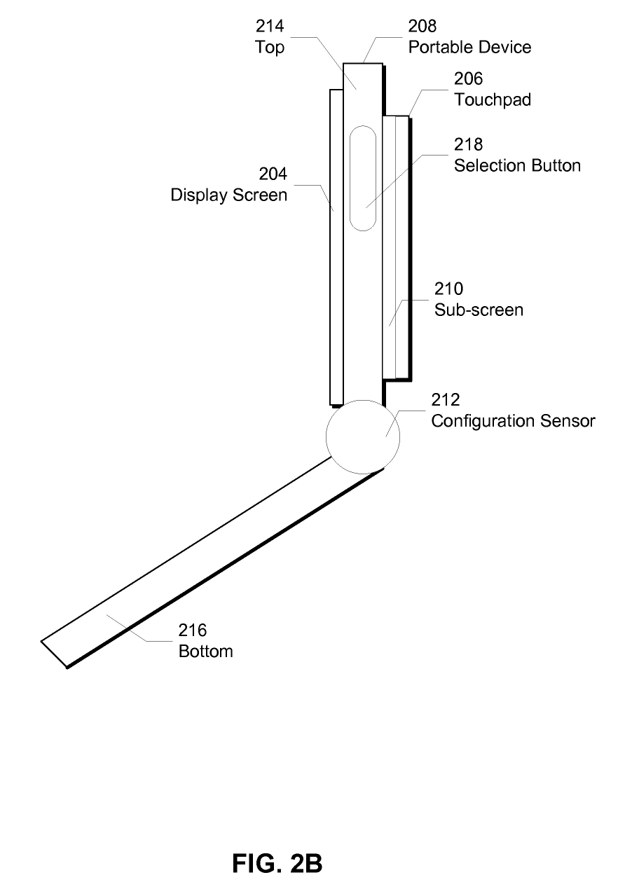

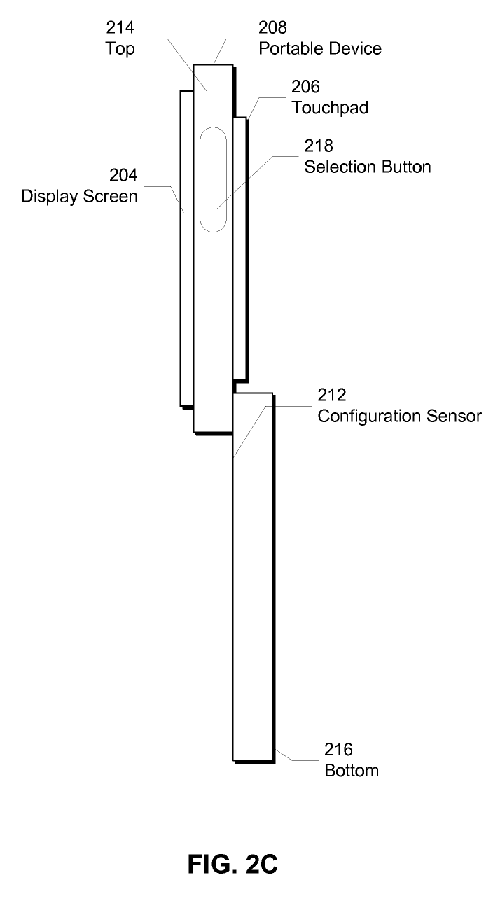

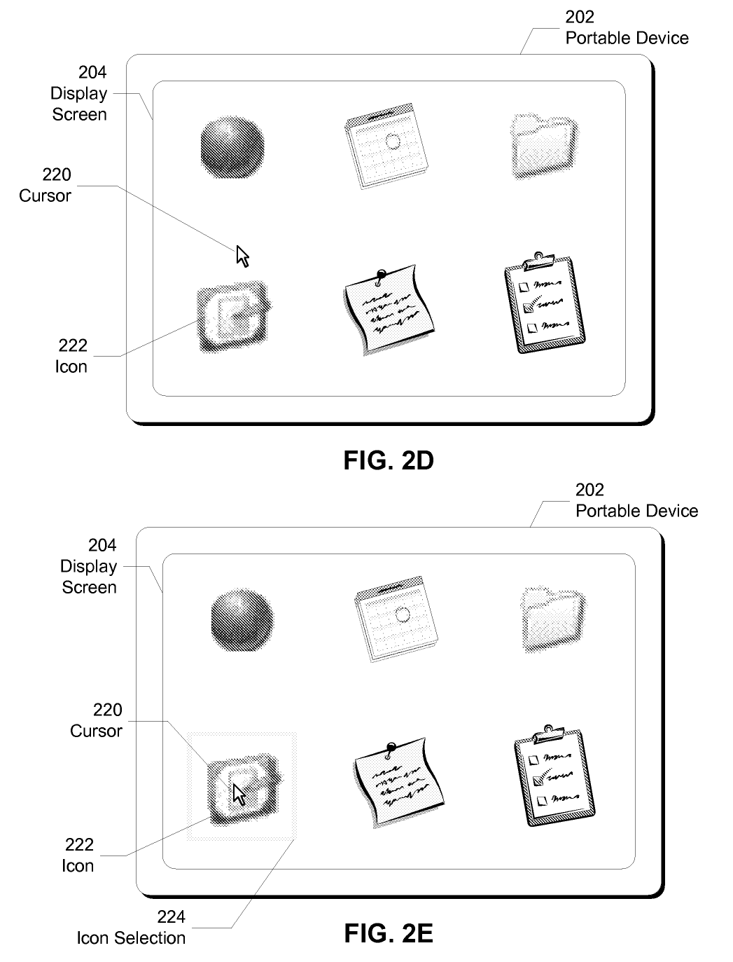

In one or more embodiments of the invention, touchpad 106 is positioned directly behind display screen 104 on the opposite side of portable device 102, as shown in FIG. 2A. Further, the dimensions of touchpad 106 may correspond to exact or scaled dimensions of display screen 104, thus allowing the user to point to positions on display screen 104 by contacting corresponding positions on touchpad 106. In other words, touchpad 106 may be configured as an absolute motion device with respect to display screen 104.

Alternatively, touchpad 106 may be shaped arbitrarily and configured as a relative motion device with respect to display screen 104. For example, display screen 104 may be shaped as a rectangle, whereas touchpad 106 may be shaped as a circle. As a result, the user may specify points on display screen 104 by dragging a cursor across display screen 104 using touchpad 106. While movements across touchpad 106 are mapped as movements across display screen 104, positions on touchpad 106 do not map directly to positions on display screen 104. In other words, relative motion across touchpad 106 may be translated as relative motion across display screen 104. In one or more embodiments of the invention, the user may specify absolute motion or relative motion between touchpad 106 and display screen 104 if touchpad 106 corresponds to a scaled version of display screen 104.

In one or more embodiments of the invention, positions on display screen 104 (i.e., screen positions) and positions on touchpad 106 are represented using coordinates. For example, display screen 104 and touchpad 106 may both be mapped to a Cartesian coordinate system with an x-axis and a y-axis. As a result, each touchpad position and/or screen position may include an x-coordinate and a y-coordinate. Those skilled in the art will appreciate that other coordinate systems, such as a polar coordinate system, may also be used.

Those skilled in the art will also appreciate that the coordinate system of touchpad 106 may correspond to a transposed version of the coordinate system of display screen 104. For example, touchpad positions may map to screen positions by transposing the x-coordinates of the touchpad positions. A touchpad position with coordinates (3, 12) may correspond to a screen position with coordinates (−3, 12). As a result, touchpad driver 112 may process the user input provided through touchpad 106 by transposing a coordinate for each of the positions inputted on touchpad 106 by the user.

In addition, movement across touchpad 106 may be translated into movement across display screen 104 by transposing a component of the movement corresponding to the axis of transposition. While movement in an absolute motion configuration between touchpad 106 and display screen 104 may be implemented by mapping each touchpad position to a screen position, no direct mapping exists between positions on touchpad 106 and display screen 104 in a relative motion configuration. As a result, the cursor may be updated on display screen 104 by sampling positions on touchpad 106 with a certain frequency, calculating a direction of movement from the sampled positions, transposing a component of the direction corresponding to the axis of transposition, and updating the cursor on display screen 104 with the transposed screen movement. Further, because the motion between touchpad 106 and display screen 104 is relative, the movement on touchpad 106 may be scaled up or down as movement on display screen 104 according to usability settings provided by the user or programmed into portable device 102.

Portable device 102 may also include multiple physical configurations. For example, portable device 102 may be constructed as a slider, clamshell, or other design that includes a “closed” configuration and an “open” configuration. In one or more embodiments of the invention, the physical configuration of portable device 102 affects the behavior and/or state of the hardware components of portable device 102. In one or more embodiments of the invention, configuration sensor 108 includes functionality to detect the physical configuration of portable device 102. Sensor driver 114 may then report the configuration to operating system 116, and operating system 116 may activate, deactivate, and/or change settings for one or more hardware and/or software components of portable device 102 based on the configuration.

Specifically, if portable device 102 includes a closed configuration that hides display screen 104 from view, operating system 116 may deactivate display screen 104. In addition, if portable device 102 includes a sub-screen (not shown) that is visible in the closed configuration, operating system 116 may activate the sub-screen as a secondary display device. In addition, touchpad 106 may be overlaid on the sub-screen such that the sub-screen is updated with user-provided positions on touchpad 106 in the closed configuration. Because of the overlay configuration between touchpad 106 and the sub-screen, the coordinate systems for touchpad 106 and the sub-screen are oriented the same way and the positions on touchpad 106 may be used directly as positions on the sub-screen.

On the other hand, if portable device 102 includes a closed configuration that obscures touchpad 106 from view and/or physical contact, operating system 116 may deactivate touchpad 106. As a result, the user may view output from display screen 104, but the user may not be able to provide input using touchpad 106. Physical configurations and interaction between hardware components of portable device 102 are described in further detail below with respect to FIG. 2B and FIG. 2C.

FIG. 2A shows an exemplary portable device in accordance with an embodiment of the present invention. Specifically, FIG. 2A shows a side view of a portable device 202 with a display screen 204 and a touchpad 206 in accordance with an embodiment of the present invention. As shown in FIG. 2A, display screen 204 is placed on one side of portable device 202, and touchpad 206 is placed on an opposite side of portable device 202 from display screen 204. Thus, while portable device 202 is in use, display screen 204 may face towards the user and touchpad 206 may face away from the user. Similarly, the user may interact with portable device 202 by viewing display screen 204 while providing input using touchpad 206. For example, the user may specify one or more screen positions on display screen 204 by contacting the corresponding touchpad positions on touchpad 206. In addition, a cursor may be shown on display screen 204 to aid the user in specifying screen positions using touchpad 206. The user may also select one or more screen positions by using increased pressure on touchpad 206, a tap on touchpad 206, a press of a button on portable device 202, and/or other mechanisms.

Because input is provided on a side of portable device 202 that is facing away from the user, the user may view display screen 204 unobstructed while using touchpad 206. Similarly, by avoiding input methods that involve physical contact with display screen 204, display screen 204 may be cleaner and less prone to damage over time.

As described above, touchpad 206 and display screen 204 may be of similar size. As a result, the user may point to screen positions on display screen 204 by contacting points on touchpad 206 directly behind the screen positions. In alternate embodiments, touchpad 206 may correspond to a scaled version of display screen 204, or touchpad 206 may have no size and/or shape correlation with display screen 204. In embodiments where touchpad 206 corresponds to the exact or scaled dimensions of display screen 204, touchpad 206 and display screen 204 may be configured for absolute motion or relative motion between one another. However, in embodiments with no dimensional correlation between touchpad 206 and display screen 204, relative motion may only be allowed between touchpad 206 and display screen 204. Similarly, while use of a cursor may be optional but useful in an absolute motion configuration between touchpad 206 and display screen 204 of comparable size, a relative motion configuration may require the use of a cursor to specify a screen position on display screen 204 from which relative movement takes place.

FIG. 2B shows an exemplary portable device in accordance with an embodiment of the present invention. Specifically, FIG. 2B shows a portable device 208 with a clamshell design in accordance with an embodiment of the present invention. As mentioned above, portable device 208 may be in an open or closed physical configuration. In addition, configuration sensor 212 may be used by portable device 208 to detect the configuration, open or closed, of portable device 208. To do so, configuration sensor 212 may detect the angle made between a top 214 and a bottom 216 of portable device 208. Those skilled in the art will appreciate that other methods of detecting physical configurations of portable device 208 may also be used. For example, a button and/or trigger may be used as configuration sensor 212. If the button/trigger is depressed, portable device 208 may be in a closed configuration, and if the button/trigger is not depressed, portable device 208 may be in an open configuration.

In one or more embodiments of the invention, an open configuration of portable device 208 (shown in FIG. 2B) corresponds to a configuration in which top 214 and bottom 216 are hinged apart from one another. In other words, portable device 208 may be in an open configuration when top 214 and bottom 216 form an angle greater than 0 degrees. Likewise, a closed configuration of portable device 208 may be detected when top 214 and bottom 216 are hinged together, touching, and/or form an angle of or close to 0 degrees. As a result, when portable device 208 is in a closed configuration, display screen 204 may be obscured from view by bottom 216.

As illustrated in FIG. 2B, portable device 208 is in an open configuration, with display screen 204 viewable by the user. The user may interact with GUI elements (e.g., icons, media, menus, sub-menus, etc.) presented in display screen 204 by using touchpad 206. As mentioned previously, touchpad 206 may be configured for relative motion or absolute motion with respect to display screen 204. The user may select one or more GUI elements on display screen 204 by positioning a cursor over the element(s) using touchpad 206 and pressing a selection button 218. The selection of the element(s) may trigger updates to display screen 204, such as the opening of a menu or sub-menu, display of an image or document, execution of one or more processes, and/or other capabilities provided by portable device 208.

In one or more embodiments of the invention, display screen 204 is inactive when portable device 208 is in a closed configuration. Further, sub-screen 210 may be activated and used as a display device in lieu of display screen 204 when portable device 208 is in a closed configuration. As shown in FIG. 2B, touchpad 206 is overlaid on sub-screen 210. As a result, touchpad 206 may be used to point to positions on sub-screen 210 when portable device 208 is in a closed configuration. Because the coordinate axes of touchpad 206 and sub-screen 210 are aligned with one another, and may even be identical, no transposition of coordinates is required to map touchpad 206 positions to sub-screen 210 positions. As with display screen 204, GUI elements on sub-screen 210 may be selected by positioning a cursor over the elements using touchpad 206 and pressing selection button 218.

FIG. 2C shows an exemplary portable device in accordance with an embodiment of the present invention. Specifically, FIG. 2C shows a portable device 208 with a slider design in accordance with an embodiment of the present invention. As mentioned previously, portable device 208 may be in an open or closed physical configuration. In addition, configuration sensor 212 may be used by portable device 208 to detect the configuration, open or closed, of portable device 208. In one or more embodiments of the invention, a vertical sliding mechanism between a top 214 and a bottom 216 of portable device 208 may allow the relative vertical positions of top 214 and bottom 216 to vary while retaining the same adjacent horizontal positions. As a result, configuration sensor 212 may detect the physical configuration of portable device 208 by detecting the vertical separation between top 214 and bottom 216 using a latch, button, trigger, and/or other mechanism.

In one or more embodiments of the invention, an open configuration of portable device 208 (shown in FIG. 2C) corresponds to a configuration in which top 214 is vertically slid apart from bottom 216. In other words, portable device 208 may be in an open configuration when top 214 and bottom 216 are vertically separated and mostly exposed to the user. Likewise, a closed configuration of portable device 208 may be detected when top 214 and bottom 216 are slid together and/or positioned vertically adjacent to one another such that one side of top 214 is covered by bottom 216 and one side of bottom 216 is covered by top 214. As a result, when portable device 208 is in a closed configuration, touchpad 206 may be obscured from view and/or physical contact by bottom 216.

As illustrated in FIG. 2C, portable device 208 is in an open configuration, with touchpad 206 accessible by the user. However, when portable device 208 is in a closed configuration, touchpad 206 may be deactivated due to the user's lack of access to touchpad 206. However, display screen 204 may remain activated to display certain GUI elements, such as a background; the date and time; incoming messages, emails, and/or calls; reminders; and/or other display elements provided by portable device 208 in a closed configuration. On the other hand, display screen 204 may also be deactivated when portable device 208 is in a closed configuration. Those skilled in the art will appreciate that the activation and/or deactivation of display screen 204 while portable device 208 is in a closed configuration may be specified and/or altered according to usability settings provided by the user or programmed into portable device 208.

FIG. 2D shows an exemplary display screen in accordance with an embodiment of the present invention. In particular, FIG. 2D may correspond to a front view of portable device 202 of FIG. 2A. As shown in FIG. 2D, display screen 204 includes a cursor 220 and an icon 222. Cursor 220 may be moved around display screen 204 by contacting a touchpad located on the backside of portable device 202, such as touchpad 206 of FIG. 2A. Cursor 220 may also be used to select icon 222. As mentioned above, selection of GUI elements in display screen 204, including icon 222, may trigger actions such as the instantiation of one or more applications, the opening of a menu and/or sub-menu, the display of one or more windows, a shutdown of portable device 202, and/or other functions provided by portable device 202.

FIG. 2E shows an exemplary display screen in accordance with an embodiment of the present invention. In FIG. 2E, icon 222 has been selected using cursor 220. As a result, icon 222 is highlighted with an icon selection 224. As described above, icon 222 may be selected by tapping on touchpad 206, increased pressure on touchpad 206, and/or pressing a selection button (not shown) on portable device 202. Icon selection 224 may cause an application associated with icon 222 to run. Alternatively, the application may run only when the user has maintained pressure on touchpad 206 or has provided a subsequent tap or button press (e.g., double-click) corresponding to icon selection 224.

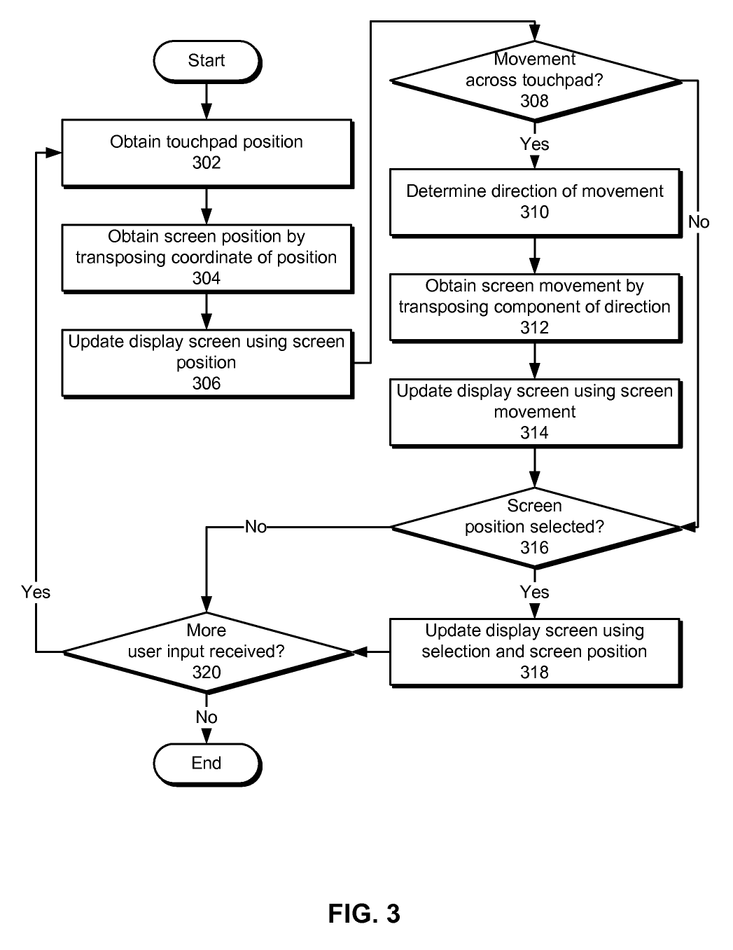

FIG. 3 shows a flow chart of processing user input in a portable device in accordance with an embodiment of the present invention. In one or more embodiments of the invention, one or more of the steps may be omitted, repeated, and/or performed in a different order. Accordingly, the specific arrangement of steps shown in FIG. 3 should not be construed as limiting the scope of the invention.

Initially, a touchpad position is obtained (operation 302). The touchpad position may be obtained from a touchpad using a touchpad driver. In addition, the touchpad may be located on a side of the portable device that is opposite a display screen on the portable device. As a result, the user may both view the display screen and provide input to the portable device using the touchpad without obscuring the display screen.

A screen position is obtained from the touchpad position by transposing a coordinate of the touchpad position (operation 304). As described above, positions on the touchpad and positions on the display screen may be identified using coordinates, such as Cartesian coordinates. However, because the touchpad and display screen are located on opposite sides from one another, the coordinate systems for the touchpad and display screen are transpositions of one another. Consequently, touchpad positions may be mapped to screen positions by transposing a coordinate (e.g., x-coordinate) of the touchpad position. Optionally, one or more coordinates of the touchpad position may be scaled to map to a corresponding screen position.

The display screen is then updated using the screen position (operation 306). As stated above, a cursor may be used to indicate the screen position. The display may be updated by placing the cursor at the screen position corresponding to the touchpad position obtained by the touchpad. In addition, the display may be updated using a highlight, an icon selection, a menu item selection, a virtual button press, and/or an area selection.

The user may also make a movement across the touchpad (operation 308). In one or more embodiments of the invention, a movement across the touchpad corresponds to sustained contact with the touchpad while moving the point of contact on the touchpad. In addition, movement across the touchpad may be used in a relative motion configuration between the touchpad and the display screen. If a movement across the touchpad is detected, the direction of the movement is determined (operation 310). To do so, touchpad positions may be sampled with a certain frequency and the direction calculated from the sampled positions. A screen movement is then obtained from the touchpad movement by transposing a component of the direction corresponding to the axis of transposition (operation 312). Optionally, the movement on the touchpad may be scaled up or down as movement on the display screen according to usability settings provided by the user or programmed into the portable device. After transformations are applied to the touchpad movement to obtain the screen movement, the display screen is updated using the screen movement (operation 314). Updates to the display screen using the screen movement may include moving the cursor, scrolling, selecting an area of the display screen, and dragging items on the display screen.

The user may select the screen position (operation 316) after specifying a touchpad position and/or making a movement across the touchpad. To select the screen position, the user may use increased pressure on the touchpad, a tap on the touchpad, and/or a press of a button on the portable device. If a selection of the screen position is detected, the display screen is updated using the selection and the screen position (operation 318). The selection of the screen position may trigger updates such as the launching of an application on the portable device, an opening of a menu, sub-menu, and/or window, a device-specific function (e.g., placing a call, sending an email, opening a document, etc.), a shutdown of the portable device, and/or other actions programmed into the portable device. The user may continue to provide more input (operation 320) using the touchpad and/or selection button(s). If so, the display screen is updated with touchpad positions, movements, and/or selections (operations 302-318) until the user has finished using the portable device.

The foregoing descriptions of embodiments have been presented for purposes of illustration and description only. They are not intended to be exhaustive or to limit the present invention to the forms disclosed. Accordingly, many modifications and variations will be apparent to practitioners skilled in the art. Additionally, the above disclosure is not intended to limit the present invention. The scope of the present description is defined by the appended claims.

What is claimed is:

1. A method for processing user input in a portable device, comprising:
obtaining a position provided by a user on a touchpad located on a first side of the portable device, wherein the position comprises a plurality of coordinates;
obtaining a screen position from the position by transposing one of the plurality of coordinates; and
updating a display screen on a second side of the portable device using the screen position, wherein the second side is located opposite the first side on the portable device.

2. The method of claim 1, further comprising:
obtaining a selection of the screen position from the user; and
updating the display screen using the selection and the screen position.

3. The method of claim 1, wherein when it is determined that the portable device is closed so that the touchpad on the first side of the portable device is not visible, the method further comprises:
deactivating the touchpad.

4. The method of claim 1, wherein when it is determined that the portable device is closed so that the display screen on the second side of the portable device is not visible, the method further comprises:
updating a sub-screen located on the first side of the portable device using the non-transposed position instead of the transposed screen position.

5. The method of claim 4, wherein the touchpad is overlaid on the sub-screen.

6. The method of claim 1, further comprising:
obtaining a movement across the touchpad by the user;
determining a direction of the movement, wherein the direction comprises a plurality of components;
obtaining a screen movement from the movement by transposing one of the plurality of components; and
updating the display screen using the screen movement.

7. The method of claim 6, wherein the movement corresponds to at least one of relative motion and absolute motion on the display screen.

8. The method of claim 1, wherein the screen position is further obtained by scaling at least one of the plurality of coordinates.

9. The method of claim 1, wherein the portable device is at least one of:
a personal digital assistant (PDA);
a mobile phone;
a portable media player;
a global positioning system (GPS) receiver; and
a portable computer.

10. The method of claim 1, wherein the display screen is updated using at least one of:
a cursor;
a highlight;
an icon selection;
a menu item selection;
a virtual button press; and
an area selection.

11. A portable device, comprising:
a touchpad on a first side of the portable device;
a display screen on a second side of the portable device, wherein the second side is opposite the first side;
a touchpad driver configured to:
obtain a position on the touchpad provided by a user, wherein the position comprises a plurality of coordinates, and
obtain a screen position from the position by transposing one of the plurality of coordinates; and
a screen driver configured to update the display screen using the screen position.

12. The portable device of claim 11, further comprising:
a sub-screen on the first side of the portable device, wherein the portable device comprises a clamshell design, wherein the screen driver is further configured to update the sub-screen using the non-transposed position when the portable device is closed.

13. The portable device of claim 11, wherein the touchpad is overlaid on the sub-screen.

14. The portable device of claim 13,
wherein the touchpad driver is further configured to obtain a selection of the screen position from the user, and
wherein the screen driver is further configured to update the display screen using the selection and the screen position.

15. The portable device of claim 14, wherein the selection is provided using at least one of:
increased pressure on the touchpad;
a tap on the touchpad; and
a press of a button on the portable device.

16. The portable device of claim 11, wherein the touchpad driver is further configured to:
obtain a movement across the touchpad by the user;
determine a direction of the movement, wherein the direction comprises a plurality of components; and
obtain a screen movement from the movement by transposing one of the plurality of components,
wherein the screen driver is further configured to update the display screen using the screen movement.

17. The portable device of claim 16, wherein the movement corresponds to at least one of relative motion and absolute motion on the display screen.

18. The portable device of claim 11, wherein the portable device is at least one of:
a personal digital assistant (PDA);
a mobile phone;
a portable media player;
a global positioning system (GPS) receiver; and
a portable computer.

19. The portable device of claim 11, wherein the screen position is further obtained by scaling at least one of the plurality of coordinates.

20. The portable device of claim 11, wherein the display screen is updated using at least one of:
a cursor;
a highlight;
an icon selection;
a menu item selection;
a virtual button press; and
an area selection.
